(19) United States
(12) Patent Application Publication
(10) Pub. No.: US 2011/0196714 A1
(43) Pub. Date: Aug. 11, 2011

(54) METHOD AND APPARATUS FOR OVERRIDING APPARENT GEO-POD ATTRIBUTES

(75) Inventors: George ERHART, LOVELAND, CO (US); Valentine MATULA, GRANVILLE, OH (US); David SKIBA, GOLDEN, CO (US)

(73) Assignee: AVAYA, INC., BASKING RIDGE, NJ (US)

(21) Appl. No.: 12/702,764

(22) Filed: Feb. 9, 2010

(51) Int. Cl. G06Q 10/00; G06Q 99/00

(52) U.S. Cl. 705/7.29; 705/325; 705/30

(57) ABSTRACT

A system and method manage the exchange of information, especially geo-location information, between a customer and an enterprise. A customer can include any person that may enter into a relationship with the enterprise. An enterprise can be any business or organization that may provide goods, services, or be involved in a relationship with a person. The customer and enterprise are involved in a transaction. Thus, the relationship with the person and the enterprise may be temporal in that it will only last for a period of time or only be involved in certain periods of time or may be temporary. The customer is able to provide customer settings. Further, during the transaction, one or more transaction settings may be established by the enterprise and the customer. As such, when the exchange of information occurs, an enterprise server or other system may be able to limit the types of information provided per the customer settings and the transaction settings.

### BACKGROUND

Some enterprises or organizations would like to discover information about customers during or after a transaction is completed. Transactions can be interactions for the sale of any good or service or other relationships between persons and enterprises. The information that an enterprise or an organization may want includes the location of the person at a moment in time, goods or other objects carried or transported by the person, personal information about the person, or other types of information that may help the enterprise enhance the transaction or improve customer service. Unfortunately, enterprises are generally not bound on what information may be retrieved. A person's geo-location may be provided to an enterprise by a third-party or a cell phone device equipped with GPS capability. However, there may be instances that the customer does not want their information provided to an enterprise or the person may want their information only provided during certain time periods. Thus, persons suffer a lack of control over the sharing of information, and further, the customer is unable to control their personal information in a secure and timely fashion.

### SUMMARY

It is with respect to the above issues and other problems that the embodiments presented herein were contemplated. The embodiments presented herein provide system(s) and method(s) for managing the exchange of information, especially geo-location information, between a customer and an enterprise. A “customer” can include any person that may enter into a relationship with an enterprise. An “enterprise” can be any business or organization that may provide goods, services, or be involved in a relationship with a person. The customer and enterprise are generally involved in a transaction. Thus, the relationship with the person and the enterprise may be temporal (i.e., the relationship will only last for a period of time), may be transient, or may be temporary. The system allows the customer to provide customer settings. Further, during the transaction, one or more transaction settings may be established by the enterprise and/or the customer. As such, when the exchange of information occurs, an enterprise server or other system may be able to limit the types of information provided for review based on the customer settings and the transaction settings. These and other advantages will be apparent from the disclosure of the invention(s) contained herein.

The geo-location provision concept uses historical information along with a decision support system to anticipate and select strategies to faithfully represent entities composed of arbitrary aggregations of individuals, events, times, items, locations, among others. The present embodiments extend the concept by providing alternative representations of entities. Alternate representations are created from any of the inputs used by the geo-location system. A simple example of an alternate representation would be a nickname known only to family and friends. Another simple example commonly in use in on-line communities is an avatar or alternate identity known to that community.

In communities, there may be levels of “reveal,” based on presentity (the entity being described by a presence system), watchers (an entity that requests presence information about a presentity), and other attributes known to those schooled in the art. Alternate representations may be based on one or more of, but are not limited to, the following: location, time, history, dialogs, responses to demos and surveys, and their various individually and mutually related semantics.

A simple example of location would be allowing full GPS access to United Airlines only for the duration of a trip while in the airport and in the air; exceptions could be, but are not limited to, when baggage was lost by the airline, and they have a business need to locate the presentity. Another simple example would be to override identity by cell phone number (associated with a particular state, e.g. Arizona) and use Geo-Pod data to reveal to a credit card contact center that an individual is on vacation and that a seemingly unusual use of a credit card is actually legitimate. A more complex example could be disguising location to family members while shopping for birthday presents, except when the presentity has a medical emergency; locations could be known from past history, the semantics of shopping locations, or the like known to those schooled in the art. Other location based examples could be different representations of, for example, truckers and other travelers, as she or he travels through different states (e.g. Arizona) with related or differing laws and other, but not limited to, attributes of geography, topography, and weather. A simple example of a time-based rule would be an alerted presentation of represented (versus salaried) employees when outside their regular working hours to assure compliance with labor contracts. Even more advanced means of disguising, altering, hiding, camouflaging, cloaking, concealing, obscuring, obfuscating, falsifying, aliasing, misrepresenting, pretending, simulating, or creating a-charade, façade, avatar, sham, pretense, pretension, delusion, false-front, delusion, put-on, speciousness, or make-believe entities may be envisioned by those schooled in the relevant arts.

The concepts presented herein advance the current art by defining a Geo-Spatial grammar that is used to match location information. The embodiments also allow correlation between multiple moving objects or people to provide proximity information. The Geo-Spatial core can make use of other information that may improve prediction of a person's motivation for their current position and direction. The embodiments also allow multiple grammar definitions to run in the core at a time. In terms of inputs, grammar and the Geo-Spatial core, this idea significantly advances the current art.

The embodiments allow input from the Geo-Spatial System based on grammar matches. However, the system takes those inputs and integrates the information with additional logic to provide avatars or alternate identities, among others as described above. The embodiments provide for alternate identities, disguises, hiding, cloaking, avatars, diversion, or the like, not found in prior Geo-Location disclosures for tracking presence of an object, such as a person or package within a carrier of such persons or packages.

The phrases “at least one”, “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine”, “calculate” and “compute,” and variations thereof, as used herein, are used interchangeably and include any type of methodology, process, mathematical operation, or technique.

The term “module” refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that aspects of the invention can be separately claimed.

The preceding is a simplified summary of some embodiments to provide an understanding of some aspects of the embodiments. This summary is neither an extensive nor exhaustive overview of the various embodiments. It is intended neither to identify key or critical elements nor to delineate the scope of the claims but to present selected concepts of the invention in a simplified form as an introduction to the more detailed description presented below. As will be appreciated, other embodiments are possible utilizing, alone or in combination, one or more of the features set forth above or described in detail below.

### BRIEF DESCRIPTION OF THE DRAWINGS

The present disclosure is described in conjunction with the appended figures:

FIG. 1 is a block diagram of an embodiment of an interaction center system operable to manage employees and conduct actions using geo-location information and other enterprise data;

FIG. 2 is a block diagram of an embodiment of an interaction center server operable to conduct actions in response to events associated with geo-location information;

FIG. 3A is a block diagram of an embodiment of a data structures that may be sent, received or stored while trying to manage and conduct actions associated with employees having associated geo-location information;

FIG. 3B is a block diagram of an embodiments of a data structure that may be sent, received or stored while trying to manage and conduct actions associated with employees having associated geo-location information;

FIG. 3C is a block diagram of an embodiments of a data structure that may be sent, received or stored while trying to manage and conduct actions associated with employees having associated geo-location information;

FIG. 4 is a flow diagram of an embodiment of a process for determining preferences for display of geo-location or other information associated with a person and/or a transaction;

FIG. 5 is a block diagram of an embodiment of a computer system that may be executed with respect to the components and systems of the embodiments presented herein;

FIG. 6 is a block diagram of a computer, which may be the same or similar to the servers, computers, devices, and/or components described herein.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only and is not intended to limit the scope, applicability, or configuration of the embodiments. Rather, the ensuing description will provide those skilled in the art with an enabling description for implementing the embodiments. Various changes may be made in the function and arrangement of elements without departing from the spirit and scope of the appended claims.

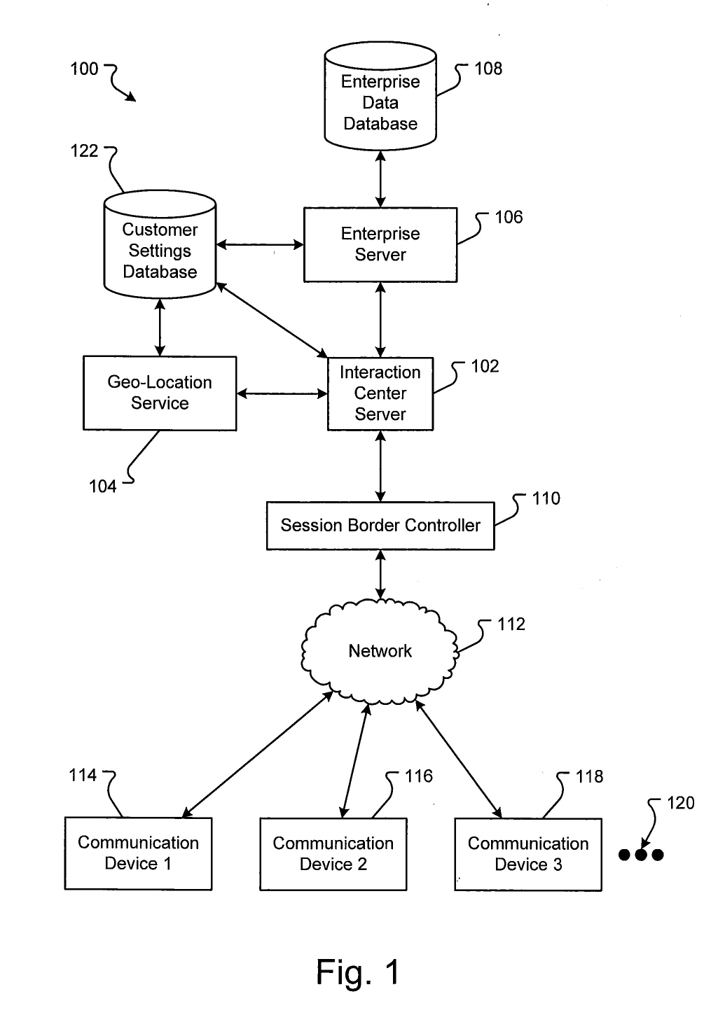

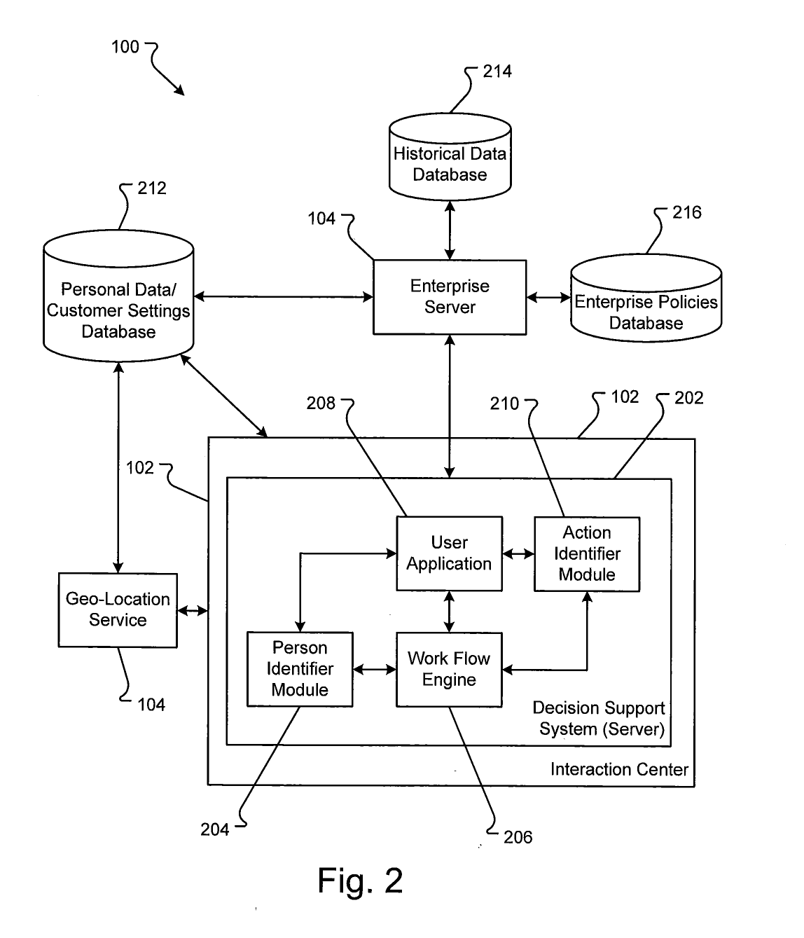

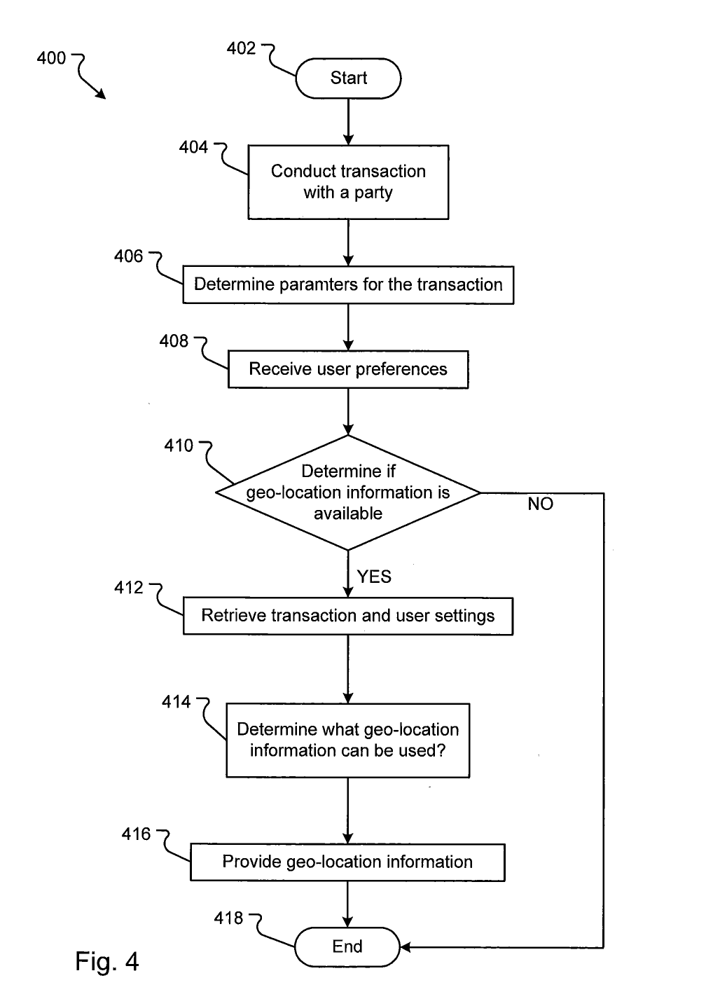

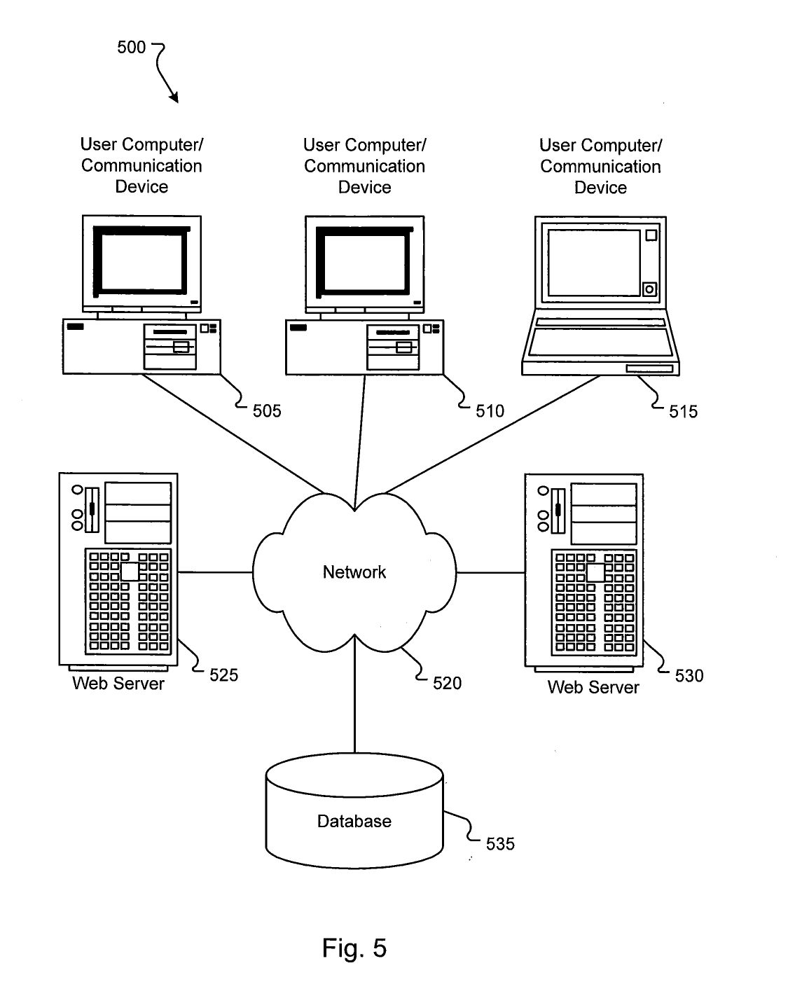

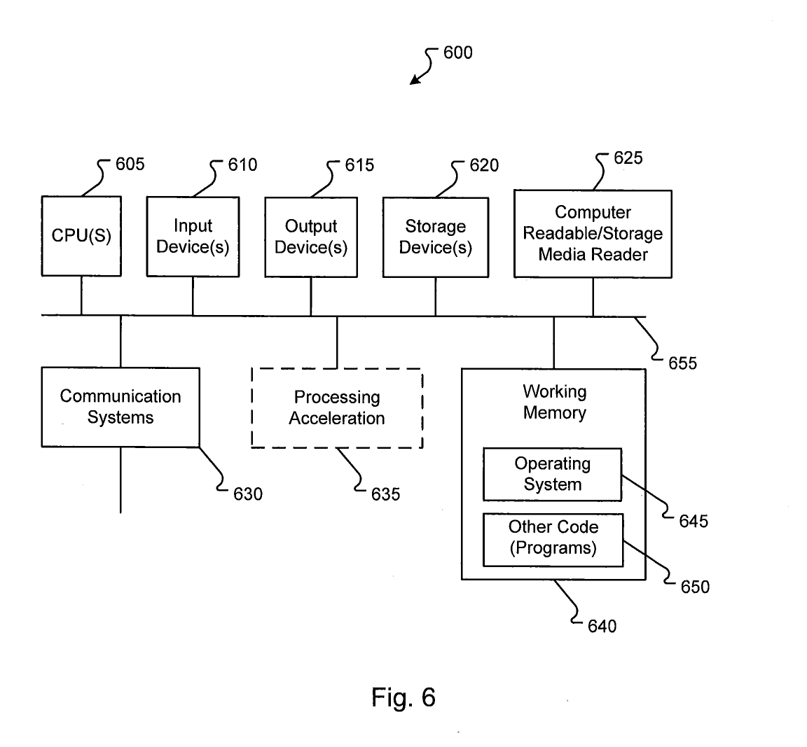

An embodiment of an interaction center system 100, for managing information about customers in a relationship with an enterprise, is shown in FIG. 1. The components and systems described in FIG. 1, and the other figures presented hereinafter, can include computer systems, or other hardware, software, or combinations of hardware and software to execute the functions as described herein. The devices and systems described in FIGS. 1 and 2 can execute the processes described in FIG. 4. Further, the systems and components can be executed in a computer system, as described in conjunction with FIGS. 5 and 6, as software modules or computer executable instructions. The systems and devices may also represent hardware wherein the functions are coded in a logic circuit, such as an application specific integrated circuit (ASIC) or a segment programmable gate array (FPGA). Herein the devices and components will be described by their function.

The interaction center system 100 can include an interaction center server 102, wherein the interaction center server 102 is operable to manage information availability. An embodiment of the interaction center server 102 is described in conjunction with FIG. 2. The interaction center server 102 may be in communication with an enterprise server 106 and a geo-location service 104. Throughout the description, the term “in communication with” is used to describe any electrical or other signal coupling between two or more components, wherein the exchange of electrical signals may be by any protocol or format regardless of whether the physical connection is wired or wireless. The interaction center server 102 is operable to receive data from both the enterprise server 106 and the geo-location service 104 to manage information associated with a person that is interacting with an enterprise.

The enterprise server 106 is operable to both manage and store data for an enterprise. An enterprise can be any organization or business that may employ the interaction center server 102. An enterprise server 106 can store data in an enterprise data database 108. The enterprise data database 108 can be any hardware and/or software operable to store data. For example, the enterprise data database 108 may be a data storage system executing a database application operable to store data in any type of database, as described in conjunction with FIG. 5. The enterprise data database 108 stores data about persons associated with the enterprise, about the relationships between the enterprise and the persons, and other information. Data about objects, such as vehicles, computers, or other property, either owned or operated by the enterprise, may also be stored in the enterprise data database 108. Other data, associated with other functions of the enterprise, may be also stored in the enterprise data database 108. The enterprise server 106 may also be operable to receive information from the interaction center server 102 to determine associated data to be retrieved from within the enterprise data database 108. The enterprise data may be retrieved from the enterprise data database 108 and sent back to the interaction center server 102.

The geo-location service 104 is operable to receive and/or provide geo-location information to the interaction center server 102. The geo-location service 104 may be part of the interaction center system 100 and included with the interaction center server 102 or may be a third-party service that provides geo-location information. The geo-location service 104 can receive geo-location information from one or more sources. For example, the geo-location service 104 can receive geo-location information from a GPS device embedded within a communication device used and carried by a person. In other embodiments, the geo-location service 104 can receive geo-location information from a radio frequency identifier reader that is able to receive signals from an RF ID card carried by a person. One or more other sources may be able to generally identify a location for a person and provide the information to the geo-location service 104. The geo-location information may then be integrated with the identity of the person and sent, by the geo-location service 104, to the interaction center server 102. As such, the interaction center server 102 can receive geo-location information for one or more persons associated with the enterprise.

The interaction center system 100 may also include a session border controller 110. A session border controller 110 functions as an interface between the interaction center server 102 and one or more communication devices, such as communication device 1 114, communication device 2 116, and/or communication device 3 118. The session border controller 110 is operable to communicate in any protocol or format across any type of network 112 to any type of communication device 114, 116, and/or 118. As such, the session border controller 110 is operable to send and receive messages over email, over a plain old telephone system (POTS), over cellular phone systems, through computer networks, or over any other type of communication media. As such, the network 112 may be any type of network that allows the session border controller 110 to communicate with the communication devices 1 114, 2 116, and/or 3 118. The communication devices 1 114, 2 116, and/or 3 118 likewise may be any type of communication devices including: mobile telephones, laptop computers, desktop computers, servers, thin client applications executing on computer systems, private branch exchanges having telephones that may be using session initiation protocol or other types of communication protocols, or other types of communication devices. There may be more or fewer types of communication devices than those shown in FIG. 1, as represented by the ellipses 120.

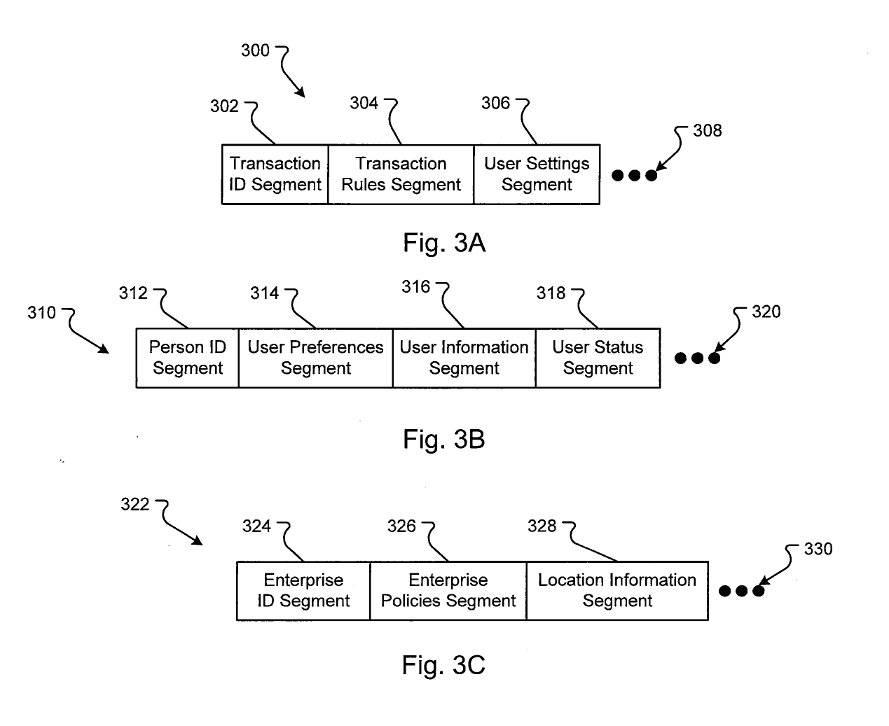

Further, the interaction center system 100 can include or communicate with a customer settings database 122. The customer settings database 122 may be the same or similar to databases described in conjunction with FIG. 5. The customer settings database 122 is managed by the interaction center server 102, the enterprise server 106, and/or the geo-location service 104. The customer settings database 122 can also be managed by a third-party and provide data to or be in communication with the geo-location service 104, the interaction center server 102, and/or the enterprise server 106. The customer settings database 122 can store and retrieve information regarding the settings the customer desires for what information will be provided during or after a transaction. Embodiments of the data structures used to store this information are described in conjunction with FIG. 3B.

Another embodiment of the interaction center system 100, showing more detail for the interaction center server 102, is shown in FIG. 2. The interaction center server 102 can include a decision support system (server) 202, which may be executed as a server or other computer system within the interaction center system 100. The decision support system 202 is operable to determine information about a user, apply business rules or business grammar, and determine information to present. The decision support system 202 can function as a management system that can automatically react to events involving one or more persons associated with the enterprise. To react to these events, the decision support system 202 can conduct actions. These actions may include modifying information presented to an enterprise.

The decision support system 202 can include a person identifier module 204, a work flow engine 206, and/or a user application 208. The person identifier module 204 can be operable to receive geo-location information from a geo-location service 104. From the geo-location information, the person identifier module 204 can extract an identity of the person that is associated with the geo-location information. For example, the person identifier module 204 can locate a person's name, a person's cell phone, a person's address, or some other information included with the geo-location information that identifies the person. The identifier or identity of the person may be sent by the person identifier module 204, to the user application 208, or to the work flow engine 206.

The action identifier module 210 is operable to determine an action that must be conducted in response to an event. For example, the action may include modifying or deleting information presented to an enterprise. There may be other actions that the action identifier module 210 can determine as one skilled in the art will understand. The action identifier module 210 is operable to identify the action based on the result of applying a rule to information received by the decision support system 202. The action may be sent to either the user application 208 and/or the work flow engine 206 to conduct the action.

The user application 208 may be a module that is operable to determine applicable business rules or grammar that should be applied to an event associated with the person. The user application 208 can communicate with the enterprise server 106. From the enterprise server 106, the user application 208 can receive information about persons, information about the enterprise or transaction, or historical data that can be used to both determine a business rule or business grammar associated with the person and information to input into the business rule. In some situations, the user application 208 can also apply the business rule to determine if an action needs to be identified by the action identifier module 210. If an action needs to be conducted, the user application 208 can send the result of the applied rule to the work flow engine 206. From there, the work flow engine 206 can retrieve the action to be conducted from the action identifier module 210.

A work flow engine 206 can complete or conduct the same operation(s) as the user application 208 or may complete other processes. For example, the work flow engine 206 may receive the action from the action identifier module 210. From the action identified, the work flow engine 206 can determine a response to the action. Thus, the work flow engine 206 can conduct the action by changing information on other messages sent to the enterprise. As such, the work flow engine 206 conducts the action identified by the action identifier module 210. In alternative embodiments, the decision support system 202 is executed by an enterprise server 106.

The enterprise server 106 can store and retrieve enterprise data from an enterprise data database 108, as explained in conjunction with FIG. 1. The enterprise data database 108 is separated into three different databases. The databases may include a personal data/customer settings database 212, a historical data database 214, and an enterprise policies database 216. The personal data/customer settings database 212 can store information about one or more persons associated with the enterprise. The data stored, about the people associated with the enterprise, is described in conjunction with FIG. 3B. The personal data may be modified or input by both the enterprise and the person that is associated with the personal data. It should be noted that the personal data and the customer settings may be stored in two or more separate databases.

The enterprise server 106 may also store and retrieve enterprise policies or grammar from an enterprise policies database 216. The data stored by the enterprise policies database 216 may be as described in conjunction with FIG. 3A and/or FIG. 3C. The enterprise policies database 216 can include a grammar that is associated with events in which the enterprise is interested. A “grammar” is a set of heuristics or rules that can be applied to certain input data. For example, a grammar can determine if an event has occurred by inputting the identity of the person involved and one or more items of geo-location information. The grammar is described as enterprise policies or business policy rules that can be set by the enterprise server 106 and applied by the decision support system 202. In other embodiments, the decision support system 202 sends information to the enterprise server 106 to determine what rules apply. Once one or more rules is determined to apply to an event, the enterprise server 106 may then send that rule back to the decision support system 202 for application of the rule.

The enterprise server 106 may also store historical data in the historical data database 214. Historical data database 214 may include information about actions or events associated with one or more persons. For example, the historical data database 214 may include previous transactions conducted with the person. As such, the enterprise server 106 can determine when a person is likely conducting a new transaction. The historical data database 214 may be provided by the enterprise server 106 to a decision support system 202 to better apply business rules and to forecast events into the future, to forecast a possible location for a person, or to forecast a trajectory for a person.

Further included in the interaction center server 102 is a personal data/customer settings database 212. The personal data/customer settings database 212 may be the same or similar to a customer settings database 122, as described in conjunction with FIG. 1. The personal data/customer settings database 212 may include the settings provided by the customer for display of information related to a transaction. The customer may set these settings during the transaction, after the transaction, or, in some embodiments, for all transactions. Thus, the customer may make one set of guidelines that covers any transaction in which the customer may be involved. The customer settings may be made before any transaction is made and supplied as each transaction is completed. The personal data/customer settings database 212 may store these settings in a data structure, as described in conjunction with FIG. 3A or 3B.

An embodiment of the transactional data structure 300, as stored within the enterprise policies database 216, is shown in FIG. 3A. The transactional data structure 300 may be stored, sent, or received by an enterprise policies database 216. The transactional data structure 300 can include a transaction identifier segment 302, a transaction rules segment 304, and a user settings segment 306. The transactional data structure 300 may have more or fewer segments than those shown in FIG. 3, as represented by the ellipses 308.

The transaction identifier (ID) in the transaction ID segment 302 can provide an identity for each transaction conducted. For example, each transaction may include a globally unique identifier (GUID) that uniquely identifies that transaction in relation to all other transactions. In other embodiments, the transaction identifier can include the names of the parties, the goods purchased, the services purchased, the time, date, and location of a transaction, or other information that uniquely identifies the transaction in comparison to all other transactions.

The transaction data structure 300 can also include transaction rules in the transaction rules segment 304. Transactions rules can include one or more rules that govern what information is displayed during or after a transaction is completed. As such, the user and the enterprise engaging in the transaction can mutually agree upon a set of transaction rules. These transaction rules may be stored in the transaction rules segment 304. As an example, transaction rules segment 304 can include information about displaying the customer's city and state, rather than an exact street location, can include information about the direction of travel, but not the speed of travel, can include information about one, but not another party that may be traveling with the user, and may include many other rules that govern what information about the user may be provided to the enterprise.

The user settings in the user settings segment 306 can include one or more rules set by a user. For example, the user may have a set of rules pre-defined in a customer settings database 122. During or after the transaction, the enterprise server 106 may access the customer settings database 122 to extract the one or more customer set rules that apply to the transaction. The rules may then be stored, in the user settings segment 306, in conjunction with the transaction. As such, the enterprise server 106 need not access or look up the customer settings each time information is exchanged, but, rather, may only have to look up the transaction data structure 300 to determine the user settings. Further, one or more new user settings may be made during the transaction which can be set in the user settings segment 306. If a conflict occurs between the user settings and the respective transaction rule, the enterprise and user may determine which rule will govern. For example, in some transactions, the transaction rule may supersede any user setting. This may be especially true if the user setting is a general rule setting made before the transaction. In other embodiments, if the user has made a special setting for this transaction, than the special user settings may supersede the transaction rules segment 304.

Referring to FIG. 3B, personal data 310 includes personal data as stored in the personal data/customer settings database 212. The personal data/customer settings database 212 may receive, store, or send one or more portions of the personal data 310 in response to interactions with the enterprise server 106. The personal data 310 may include one or more segments. The personal data 310 may have more or fewer segments than those shown in FIG. 3B, as represented by ellipses 320. The personal data 310 can include a person identifier segment 312, a user preferences segment 314, a user information segment 316, and a user status segment 318.

The person identifier (ID) segment 312 includes an identifier for a person. The person ID can be a globally unique identifier (GUID) or some other numeric or alphanumeric identifier for the person. In other embodiments, the person ID in the person ID segment 312 includes a name, a cell phone number, an address, or some other characteristic specific to a person. The persons associated with personal data 310 generally have relationships with the enterprise. For example, the person may be a customer. The person ID in the person ID segment 312 can be used by the person identifier module 204 to identify geo-location information associated with that person.

The personal data 310 can also include a user preferences segment 314. User preferences segment 314 can include one or more settings that may be provided or applied by the person. The user preferences segment 314 may also include one or more settings from the user. The user preferences are the one or more settings provided by a user for what information and how the information will be displayed to an enterprise. The user preferences may be set before a transaction and applied to each transaction that involves the user. The user preferences may also be created and applied when each transaction is conducted, where the user sets specific and particular user preferences for the particular transaction. The user can set special preferences 314 for each transaction. After receiving the user preferences, the user preferences may be stored in the user preferences segment 314.

The user settings segment 306 in the transaction data structure 300 may have a pointer to the corresponding user preferences. User preferences can include the type of identity displayed for the user. For example, the user may use an icon, an avatar, a photograph, a nickname, or some other identity that is not necessarily the name of the user. The user preferences may also specify what information cannot be provided to an enterprise, such as, the speed of travel, a specific destination of the user, or any information that is not to be provided beyond a predetermined period of time. For example, the user is involved with an airline in a travel arrangement; the user may only allow the airline to know the location of the user for one hour before and after the flight.

User information in the user information segment 316 can also include characteristics about the employee or other person associated with the enterprise. User information can be public information or information that the enterprise is able to discern or retrieve from interaction(s) with the person or from other sources. For example, user information can include the person's name, address, phone number, their working hours, their job description, or other information associated with the person and accessible to the enterprise.

A user status segment 318 includes the status of the user at any given period of time. Thus, the user status can be dynamic and change over time. The user status may include statuses consisting from furlough, leave, closure, sabbatical, holiday, or vacation. Thus, when a user leaves for vacation, the user status goes from working to vacation. As such, the enterprise server 106 is aware of the status of the user at any given point of time. With the user status being stored, the enterprise server 106 can automatically apply the appropriate transaction rule(s) applicable to different employees based upon their user status.

An embodiment of an enterprise policies data structure 322, which can be stored in an enterprise policies database 216, is shown in FIG. 3C. The enterprise policies database 216 can include information about the enterprise or different information about characteristics or objects associated with the enterprise. The enterprise policies data structure 322 can include more or fewer segments than those shown in FIG. 3C as represented by ellipses 330. The enterprise policies data structure 322 includes an enterprise identifier (ID) segment 324, an enterprise policies segment 326, and/or a location information segment 328.

The enterprise ID stored in the enterprise ID segment 324 can be a GUID, a name of the enterprise, or some other identifier that uniquely identifies the enterprise. The enterprise ID may be associated with one or more enterprise policies in the enterprise policies segment 326. An enterprise policy may be a general guideline that applies to the enterprise or to one or more events associated with the enterprise. The enterprise policy may include one or more rules, such as the transaction rules described in conjunction with FIG. 3A. Each enterprise may have one or more organization(s) and thus include one or more enterprise identifiers. Further, each organization may have one or more enterprise policies associated with each enterprise ID and stored in the enterprise policies segment 326.

The enterprise policies data structure 322 can also include location information in the location information segment 328. Some enterprise policies or transaction rules may be associated with buildings or with objects that the enterprise operates or owns. For example, one transaction rule may apply to a manufacturing facility. Likewise, an enterprise policy may apply to an automobile that is used by one or more employees. As such, the location information for these different locations or objects is stored in the location information segment 328.

An embodiment of a method 400, for limiting the amount of information provided to an enterprise, is shown in FIG. 4. Generally, the method 400 begins with a start operation 402 and terminates with an end operation 418. While a general order for the steps of the method 400 are shown in FIG. 4, the method 400 can include more or fewer steps or arrange the order of the steps differently than those shown in FIG. 4. The method 400 can be executed as a set of computer-executable instructions executed by a computer system and encoded or stored on a computer readable medium. Hereinafter, the method 400 shall be explained with reference to the systems, components, modules, software, data structures, etc. described in conjunction with FIGS. 1-3C.

An enterprise and a party conduct a transaction, in step 404. The enterprise server 106 can conduct the transaction with a party. The party may be a business or a person. The transaction creates a transactional relationship between the party and the enterprise. The transactional relationship can be defined by one or more transaction rules. The transaction rules can include definitions of how information will be shared between the party and the enterprise. After or during completion of the transaction, the transactional rules for the transactional relationship can be stored in the transactional data structure 300.

Thus, the enterprise and the party can determine parameters for the transaction, in step 406. The parameters suggest what types of information and when that information may be provided to the enterprise server 106. Further, the enterprise server 106 may also receive user preferences from the user preferences segment 314, in step 408. The user preferences may be pre-defined by the user or may be defined incident to the transaction. The user preferences can be stored in a customer settings database 122 in which the enterprise server 106 communicates with and from which extracts the information. Also, the enterprise server 106 may store the user settings, in the user settings segment 306, as described in FIG. 3A. In other embodiments, the customer settings database 122 includes a personal data 310, as described in conjunction with FIG. 3B. The enterprise server 106 may create a pointer in the user settings segment 306 that points to the personal data 310. As such, the enterprise server 106 can extract the user preferences, from the user preferences segment 314, in personal data 310.

Either during the transaction or at a time thereinafter, the interaction center server 102 can determine if geo-location information is available for the party, in step 410. The enterprise server 106 may send a request to the interaction center server 102 for geo-location information at a time specified in the appropriate transaction rules in the transaction rules segment 304. At that time, the interaction center server 102 may contact the geo-location service 104 to determine if there is geo-location information available for the party. If there is geo-location information available, the step 410 flows “YES” to step 412. If there is no geo-location information available, the step 410 flows “NO” to the end operation 418.

The interaction center server 102, after determining geo-location information is available, may request the transaction rules from transaction rules segment 304, the user settings from the user settings segment 306, and/or user preferences from the user preferences segment 314, in step 412. From this information, the interaction center server 102 can determine what information to provide the enterprise server 106. Thus, the interaction center server 102 can determine what geo-location information can be used, in step 414. The interaction center server 102 applies a transaction rule in the user settings to redact or remove one or more piece(s) of geo-location information. The geo-location information can include speed, locations, parties that are near the party, goods or objects in the possession of the party, or other information. One or more of these items of geo-location information may be redacted from the set of geo-location information received from the geo-location service 104 or determined by the interaction center server 102. The redacted geo-location information may then be provided to the enterprise server 106, in step 418.

The interaction center server 102 can send the geo-location information to the enterprise server 106 on a periodic or continuous basis. As such, the geo-location information is continually or consistently updated. The period of time for receiving the geo-location information may expire. In this case, the enterprise server 106 may send a request to the interaction center server 102 to no longer provide this geo-location information. In other embodiments, this period of time may be sent to the interaction center server 102 as a part of the transaction information. As such, when the time period has been reached, the interaction center server 102 can automatically cancel the provision of geo-location information to the enterprise server 106. The geo-location information or information provided to the enterprise server 106 can include one or more of, but is not limited to, speed information, travel history, event attendance, objects and possession of the first party, the identity of the first party, identity type of the first party, or a predicted destination.

If the geo-location information is received after a transaction, it may be necessary for the interaction center server 102 to determine the transaction. As such, the interaction center server 102 may send the identity of the party to the enterprise server 106. The enterprise server 106 may look for this user identity in transactional information in the transactional data structure 300. In other embodiments, the party may be associated with a transaction identifier in the transaction ID segment 302 in which case the enterprise server 106 can search for the transaction identifier. In these situations, after determining the one or more associated transactions, the enterprise server 106 may send one or more sets of transaction rules in the transaction rules segment 304 and/or user settings in the user settings segment 306 to the interaction center server 102. Thus, each transaction may initiate the process 400.

### EXAMPLES

In an example of the method described in FIG. 4, the first party may be a consumer who transacts with a commercial enterprise for a good or service. The commercial enterprise may want to know the location of the user for a period of one hour after the transaction. In this way, if there are any changes to the commercial transaction, the commercial enterprise may locate and contact the first party. However, the first party may not want their full name given to a customer service entity, and thus, in the user settings in the user settings segment 306, may express a desire to have the consumer service representative to see a nickname or a first name. This limitation may be further important if the transaction is between two people rather than between a person and a business. The second party may only want to see the nickname rather than their full name.

In another example, a user may fly on an airline. After arriving at a destination, the airline may want to track the user's location for a period of time after the landing. In this way, if there is a problem with the luggage of the user, the airline may be able to locate the user to explain to them the new situation. Thus, during the transactional relationship establishment, the airline may create a rule that requires the user to provide their location for an hour after landing.

In yet another example, the user may have a relationship with a credit card company that establishes transactional rules. One of the rules may be that the credit card company can access the location of the consumer during a credit card transaction. As such, if the consumer is purchasing gas at a gas station, the credit card company may correlate the incoming credit card transaction location with the geo-location information of the user to determine if it is actually the user who is using the credit card. This type of information may enhance the security of the credit card, prohibiting people from fraudulently using credit cards and may also prevent a credit card company from mistakenly believing that a credit card has been stolen if the user is on vacation or not in a normal location.

Further, a user may have a birthday present that they have purchased and are headed towards a destination. However, the user may not want a family member or another member, who may be receiving geo-location information, to know that there is a birthday present in the possession of the person. As such, the user may request, during the transaction to purchase the birthday present, to prohibit this information from being presented to other parties.

FIG. 5 illustrates a block diagram of a system 500 that may function as servers, computers, or other systems provided herein. The system 500 includes one or more user computers 505, 510, and 515. The user computers 505, 510, and 515 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 505, 510, 515 may also have any of a variety of applications, including for example, database client and/or server applications, and web browser applications. Alternatively, the user computers 505, 510, and 515 may be any other electronic device, such as a thin-client computer, Internet-enabled mobile telephone, and/or personal digital assistant, capable of communicating via a network (e.g., the network 520 described below) and/or displaying and navigating web pages or other types of electronic documents. Although the exemplary system 500 is shown with three user computers, any number of user computers may be supported.

System 500 further includes a network 520. The network 520 may can be any type of network familiar to those skilled in the art that can support data communications using any of a variety of commercially-available protocols, including without limitation SIP, TCP/IP, SNA, IPX, AppleTalk, and the like. Merely by way of example, the network 520 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 502.11 suite of protocols, the Bluetooth™ protocol known in the art, and/or any other wireless protocol); and/or any combination of these and/or other networks.

The system may also include one or more server computers 525, 530. One server may be a web server 525, which may be used to process requests for web pages or other electronic documents from user computers 505, 510, and 520. The web server can be running an operating system including any of those discussed above, as well as any commercially-available server operating systems. The web server 525 can also run a variety of server applications, including SIP servers, HTTP servers, FTP servers, CGI servers, database servers, Java servers, and the like. In some instances, the web server 525 may publish operations available operations as one or more web services.

The system 500 may also include one or more file and or/application servers 530, which can, in addition to an operating system, include one or more applications accessible by a client running on one or more of the user computers 505, 510, 515. The server(s) 530 may be one or more general purpose computers capable of executing programs or scripts in response to the user computers 505, 510 and 515. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 530 may also include database servers, including without limitation those commercially available from Oracle, Microsoft, Sybase™, IBM™ and the like, which can process requests from database clients running on a user computer 505.

The web pages created by the web application server 530 may be forwarded to a user computer 505 via a web server 525. Similarly, the web server 525 may be able to receive web page requests, web services invocations, and/or input data from a user computer 505 and can forward the web page requests and/or input data to the web application server 530. In further embodiments, the server 530 may function as a file server. Although for ease of description, FIG. 5 illustrates a separate web server 525 and file/application server 530, those skilled in the art will recognize that the functions described with respect to servers 525, 530 may be performed by a single server and/or a plurality of specialized servers, depending on implementation-specific needs and parameters. The computer systems 505, 510, and 515, file server 525 and/or application server 530 may function as the devices, components, or systems described herein.

The system 500 may also include a database 535. The database 535 may reside in a variety of locations. By way of example, database 535 may reside on a storage medium local to (and/or resident in) one or more of the computers 505, 510, 515, 525, 530. Alternatively, it may be remote from any or all of the computers 505, 510, 515, 525, 530, and in communication (e.g., via the network 520) with one or more of these. In a particular set of embodiments, the database 535 may reside in a storage-area network (“SAN”) familiar to those skilled in the art. Similarly, any necessary files for performing the functions attributed to the computers 505, 510, 515, 525, 530 may be stored locally on the respective computer and/or remotely, as appropriate. In one set of embodiments, the database 535 may be a relational database, such as Oracle 101™, that is adapted to store, update, and retrieve data in response to SQL-formatted commands.

FIG. 6 illustrates one embodiment of a computer system 600 upon which the servers, computers, or other systems or components described herein may be deployed or executed. The computer system 600 is shown comprising hardware elements that may be electrically coupled via a bus 655. The hardware elements may include one or more central processing units (CPUs) 605; one or more input devices 610 (e.g., a mouse, a keyboard, etc.); and one or more output devices 615 (e.g., a display device, a printer, etc.). The computer system 600 may also include one or more storage devices 620. By way of example, storage device(s) 620 may be disk drives, optical storage devices, solid-state storage devices such as a random access memory (“RAM”) and/or a read-only memory (“ROM”), which can be programmable, flash-updateable and/or the like.

The computer system 600 may additionally include a computer-readable storage media reader 625; a communications system 630 (e.g., a modem, a network card (wireless or wired), an infra-red communication device, etc.); and working memory 640, which may include RAM and ROM devices as described above. In some embodiments, the computer system 600 may also include a processing acceleration unit 635, which can include a DSP, a special-purpose processor, and/or the like.

The computer-readable storage media reader 625 can further be connected to a computer-readable storage medium, together (and, optionally, in combination with storage device(s) 620) comprehensively representing remote, local, fixed, and/or removable storage devices plus storage media for temporarily and/or more permanently containing computer-readable information. The communications system 630 may permit data to be exchanged with the network 620 and/or any other computer described above with respect to the system 600. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 600 may also comprise software elements, shown as being currently located within a working memory 640, including an operating system 645 and/or other code 650. It should be appreciated that alternate embodiments of a computer system 600 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for providing information about a first party associated with a transaction, the method comprising:
a processor establishing a transactional relationship between a first party and a second party, wherein the transactional relationship is defined by a rule;
the processor receiving geo-location information for the first party;
the processor identifying the first party;
in response to identifying the first party, the processor determining the transactional relationship associated with the first party;
the processor retrieving the rule associated with the transactional relationship;
the processor presenting information about the first party to the second party, wherein the information presented is defined at least in part by the rule.

2. The method as defined in claim 1, wherein the rule is established by the first party.

3. The method as defined in claim 2, wherein the rule is associated with every transaction associated with the first party.

4. The method as defined in claim 1, wherein the first party is a person and the second party is a commercial enterprise.

5. The method as defined in claim 1, wherein the rule includes at least one restriction about information that may be provided to the second party.

6. The method as defined in claim 1, wherein the rule is established incident to the transaction.

7. The method as defined in claim 1, wherein the information includes at least one of a group consisting of location information, speed information, travel history, event attendance, objects in possession of the first party, identity of the first party, identity type of the first party, or a predicted destination.

8. A computer readable medium having stored thereon instructions that cause a computing system to execute a method for conducting an action associated with a geo-location, the instructions comprising:
instructions to receive transaction information associated with a transaction between a first party and a second party;
instructions to establish a transactional relationship between the first party and the second party;
instructions to receive a first rule incident to the transaction, wherein the first rule defines for the transaction what information about the first party may be provided to second party;
instructions to receive a second rule associated with the first party, wherein the second rule defines for the first party what information about the first party may be provided to second party;
instructions to receive geo-location information for the first party;
instructions to identify the first party;
in response to the identification the first party, instructions to determine the transactional relationship associated with the first party;
instructions to retrieve the first rule and the second rule associated with the transactional relationship and the first party;
instructions to present information about the first party to the second party, wherein the information presented is defined at least in part by the first rule and the second rule.

9. The method as defined in claim 8, wherein the second rule is established by the first party and the first rule is established by the second party.

10. The method as defined in claim 8, if the second rule and the first rule conflict, instructions to adopt the second rule.

11. The method as defined in claim 8, wherein the first party is a person and the second party is a commercial enterprise.

12. The method as defined in claim 11, wherein the transaction is the sale of a good or service.

13. The method as defined in claim 8, wherein the first rule applies to all transactions associated with the second party.

14. The method as defined in claim 8, wherein the information provided to the second party includes at least one of a group consisting of location information, speed information, travel history, event attendance, objects in possession of the first party, identity of the first party, identity type of the first party, or a predicted destination.

15. An interaction center system for an enterprise comprising:
an enterprise server operable to store information about a transaction associated with a first party and a second party, operable to provide personal information about the first party, and operable to provide a rule associated with the transaction;
an interaction center server in communication with a geo-location service and the enterprise server, the geo-location service being operable to provide geo-location information for the first party, and the interaction center server being operable to:
receive the rule from the enterprise server;
receive geo-location information for the first party associated with the enterprise;
identify the first party associated with the geo-location information;
in response to identifying the first party, determine the rule applies to the first party;
redact a portion of the geo-location information in correspondence with the rule; and
send the non-redacted portion of the geo-location information to the enterprise server.

16. The communication system as defined in claim 15, further comprising a customer settings database in communication with the enterprise server, the customer settings database operable to provide the rule to the enterprise server.

17. The interaction center system as defined in claim 16, wherein the rule is a user-defined parameter defining what geo-location information is to be redacted.

18. The interaction center system as defined in claim 15, wherein the interaction center server comprises:
a decision support server, the decision support server executing:
a person identifier module operable to identify the first party;
a user application operable to send and received information with the enterprise server and operable to determine the which geo-location information to redact; and
a work flow engine in communication with the person identifier module, action identifier module, and user application, the work flow engine operable to conduct the action, wherein the work flow engine conducts the action by at least communicating with a communication device.

19. The interaction center system as defined in claim 15, wherein the enterprise server is in communication with at least one of an enterprise policies database and a historical data database.

20. The interaction center system as defined in claim 19, wherein the enterprise policies database includes enterprise policies database stores the rule, wherein the rule is defined by the transaction.
